(19) United States
(12) Patent Application Publication
(10) Pub. No.: US 2009/0324810 A1
(43) Pub. Date: Dec. 31, 2009

(54) METHOD FOR PRODUCTION OF DIAMOND ELECTRODES

(76) Inventors: Roberto Massahiro Serikawa, Kanagawa (JP); Kenichi Sasaki, Kanagawa (JP); Martin Rueffer, Amberg (DE); Michael Foreta, Schwabach (DE)

Correspondence Address: BROWDY AND NEIMARK, P.L.L.C.;624 NINTH STREET, NW, SUITE 300, WASHINGTON, DC, 20001-5303, US

(21) Appl. No.: 12/282,047

(22) PCT Filed: Feb. 26, 2007
(86) PCT No.: PCT/JP2007/054111

§ 371 Date: Mar. 2, 2009

(30) Foreign Application Priority Data
Mar. 7, 2006 (JP) 2006-060975

(51) Int. Cl. B05D 5/12

(52) U.S. Cl. 427/78

(57) ABSTRACT

The invention is related to the method for production of diamond electrode with improved stability for use in electrochemical reaction. The method concerns to the production of diamond electrodes where the diamond layer is composed of small sized grain, avoiding the delamination problems found in conventional diamond electrodes.

### TECHNICAL FIELD

The present invention concerns to a method for producing diamond electrodes with improved stabilities for use in aqueous media. The diamond electrode with improved stabilities can be used, in treatment of industrial and urban wastewater, in disinfection of freshwater and seawater, in electrochemical organic/inorganic synthesis and in electrochemical sensor for detection of dilutes compounds in the water or other application of electrode in aqueous media.

### BACKGROUND ART

Diamond is known to be one of hardest materials which allow its application in tools for machining mechanical components such as drills and grinders. Besides these physical properties of diamond, in last two decades, peculiar electrochemical properties of diamond has been found when used as electrodes. Diamond electrodes show a large thermodynamic windows and exhibit efficient production of OH radical from the water. Peculiar electrochemical properties of diamond have been working as an incentive for development of new application such as a sensor and electrodes for water treatment process or electrochemical synthesis. These diamond electrodes are produced by coating a conductive substrate; such as silicon, graphite, or metal like Niobium, Titanium, Tungsten, Molybdenum, Tantalum, or other electrically conductive and high temperature resistant material; with a layer of conductive diamond by Chemical Vapor Deposition (CVD) process. Natural diamonds are electrically insulating material but when the diamond are doped with a P-type dopant or N-type dopant; N-type semi-conductor or P-type semiconductor diamond layer can be fabricated by the CVD process. Basically two types of CVD process are commonly used for coating the substrate material: hot filament CVD (HF-CVD) or microwave-CVD (MW-CVD). Between these two CVD methods, HF-CVD has been advantageously used for coating large area electrodes. Large area coating can be performed by the HF-CVD disposing an array of filament inside the CVD chamber. In the CVD coating process, the substrate material are coated with a poly-crystalline diamond layer when the substrate are heated to around 700-900° C. in presence of a hydrogen radical, carbon and dopant source. The hydrogen radical source is usually hydrogen gas activated by hot filament or plasma generated by the microwave; depending on the type of the CVD. The hydrogen radical are produced by activating the hydrogen gas by the hot filament kept at around 1,800 to 2,400° C. or plasma at temperature 1,500 to 6000° C. Several carbon sources can be used for this CVD coating but one commonly used compound is methane gas kept at concentration around 0.5 to 10 volume percent (hereinafter %) in hydrogen atmosphere. During the CVD process, sp³ carbons (diamond carbon) and sp² carbons (non-diamond carbon) are formed at the same time. However, because the hydrogen radicals react preferentially with sp² carbons, the deposition of sp³ carbon over the substrate material can take place inside of CVD chamber This deposition of sp³ carbon allows the growing of diamond crystals over the substrate material. Several dopant source can be used depending on the type of semiconductor diamond in interest, but one of the most common dopant is Boron in form of diborane, tri-methyl boron or boron dioxide at concentration of less than one volume percent in hydrogen atmosphere; for the production of p-type conductor diamond layer.

Prior arts have disclosed methods for producing diamond electrodes using the CVD process.

JP 2004-231983 (A) discloses a method for production of diamond electrodes in which the electrodes comprise two layers of diamond; being at least one layer of conductive diamond. Furthermore, this patent discloses the manufacturing of diamond layer with different grains sizes to improving the stability during electrochemical process. Changes in methane concentration and substrate temperature during the CVD process are suggested for controlling the grain size in different diamond layers. The disclosed CVD coating pressure is ranging from 90 mBar to 160 mBar (9-16 kPa).

JP 2003-147527(A) discloses another method for production of diamond electrode by coating graphite substrates. The disclosed electrode has an intermediate diamond layer with grain size lower than 10 nm. Also here, for production of such fine grain size layer, the increase in the methane concentration to values higher than 5% is proposed. The disclosed CVD coating pressure is ranging from 67 to 75 mBar (6.7-7.5 kPa)

The usual CVD condition for production of diamond electrodes in the majority of previous art can be summarized as bellow;

Methane concentration: 0.5-10%

CVD chamber pressure: 26-160 mBar (2.6-16 kPa)

CVD Atmosphere: Hydrogen

Features in the previous art focus on the improvement of diamond stability by producing small grains diamond which can works as a barrier for the electrolyte solution. The methodology to obtain a diamond layer with small grain size is by controlling the methane concentration to value higher than one percent or by controlling the temperature of the substrate to low value.

In the previous application of the present inventors, WO2005/113448 A1, diamond electrode with improved stability was also disclosed in which the electrode is composed of alternated layer with different grain sizes. The layer was produced at 7 mBar and the technique to change the grain size here was also changing the methane concentration between 1 and 2%. Also the variation of CVD temperature is disclosed as a method to change the grain size.

This invention relates to an improvement of the prior application and prior art.

### DISCLOSURE OF THE INVENTION

Diamond electrodes exhibits fascinating properties for example in removing COD component in aqueous medium due to the huge amount of OH radical produced in its surface. Such performance can not be achieved by other conventional electrode such as graphite electrode, platinum or other noble metal electrode like DSE (dimensionally stable electrode). Although diamond electrode performance being very promising; the industrial applicability has been strongly limited by its poor stability when used in almost all types of electrolytic reaction in aqueous medium. Current DSE used in the Chloro-Alkali industry has stability longer than several years, but in comparison, the stability of actual diamond electrodes are extremely short. It is known by the status of art that when electrode with large diamond layer thickness; for example higher than 50 micrometer is used, such life time requirement can be cleared. Due to the difference in thermal expansion coefficient, such high thickness diamond can be coated only in silicon substrates. When Niobium or other metals are used as the substrate, there is a bending of electrode due to the high temperature coating. Also there is a problem of remaining stress in the coating, which usually contributes to decrease the life time of electrode. High thickness diamond coating are possible over the silicon substrate, but the CVD coating cost of such large thickness diamond layer will become prohibitive for a commercial use. Therefore, the scope of present invention is to provide a diamond electrode and a method for production of diamond electrode with lower production cost and improved stability.

Basically, two mechanisms strongly contribute for the fail or break-down of diamond electrode during the electrolytic reaction: etching and delamination of diamond layer. On one hand, the etching of the diamond layer is a process that slowly deteriorates the diamond electrodes. It is thought that the etching mechanism proceeds by a chemical oxidation where the electrochemically produced OH radicals formed in the diamond surface attacks the diamond layer itself. These OH radical are the oxidant that promote the COD compound oxidation during wastewater treatment or kill the microorganisms during the water disinfection. The performance of diamond electrodes are attributed to the production of this strong oxidant, but at the same time, this strong oxidant works to corrode the diamond layer itself. Microscopically, the etching of the diamond layer proceeds by the attack of OH radical to the parts in which the diamond layer has weak chemical stability. Such weak parts are twins defects in the diamond grains, specific crystal orientation where the dopant or sp² carbon tends to concentrate and inter-granular region. Macroscopically, it can be said that the etching proceed homogeneously in the whole surface of diamond electrode but in a very slow speed.

On the other hand, the delamination of diamond layer is a mechanism that rapidly causes the fail of diamond electrode. The delamination of the diamond layer proceeds by the detachment of diamond layer from the substrate material. Macroscopically, the delamination starts in a heterogeneous way in the diamond electrode surface, but quickly propagates to the whole surface. The delamination mainly happens due to the corrosion of interlayer, which is a middle layer that bonds the diamond layer and the substrate material. This bonding interlayer is formed at the beginning of the CVD coating process and its chemical composition varies depending on the used substrate material in the CVD coating process. The interlayer composition will be, for example, silicon carbide, titanium carbide or niobium carbide when the used substrate is silicon, titanium or niobium, respectively. These carbides interlayer has poor stability against the electrochemical attack of electrolyte solution during the electrolytic process. The diamond layer over this carbide interlayer has to work as a barrier against the electrolyte solution during the electrolytic process to avoid this delamination. However, defects in the diamond layer surface such as pinholes, or the inter-granular etching of poly-crystalline layer allows the penetration of electrolyte solution starting the delamination FIG. 1 shows a schematic illustration of delamination mechanism originated by pinhole. These pinholes tends to appear in the layer when the condition for CVD coating is likely to form large diamond grains. There is almost a straight path for the electrolyte solution to reach the carbide interlayer when the grains are bigger. The sp² carbons and the dopant, which causes the decrease of chemical stability of the diamond layer, tend to accumulate in the grain boundary region. Even in the case that there is not a pinhole at the beginning, because the inter-granular regions are preferentially etched, the pinhole are easily formed during the electrolytic process. Despite the nuclei of diamond grains being resistant against the electrochemical etching, this sub-surface migration of the electrolyte causes the delamination of diamond layer. This penetration of electrolyte solution through pinholes or inter-granular etching is illustrated in FIG. 1a and this happens mainly when the diamond layer is comprised by large poly-crystalline diamonds. Specifically speaking, this penetration of electrolyte solution through the diamond layer easily happens when the diamond grain size is larger than one micrometer. During the coating process in the CVD chamber, the diamond crystal tends to grow in a columnar structure, which means, the grain has longitudinal dimension larger than width dimension. More specifically speaking, this problem of electrolyte penetration can happen when the width dimension of diamond grain is larger than one micrometer. Once a delaminated area appears at the electrode surface, the electrolyte solution easily attacks the carbide interlayer in the vicinity of delaminated area, propagating the delamination to the whole electrode surface. This propagation of delaminated area by the sub-surface migration of electrolyte solution is illustrated in FIG. 1b.

FIG. 2 shows a cross section of another embodiment of diamond electrode with different structure, which is one of preferred embodiment of present invention. In this embodiment of diamond electrode, the diamond layer is composed of small grains with size between 0.1-800 nm in width; preferable in the range between 1-500 nm; more preferable in the range between 1-300 nm. Because of the small grain size, the diamond layer is compact and has a minute structure which avoids the pinhole or cavity. This structure has the advantage in blocking the penetration of electrolyte solution. Furthermore, even when the inter-granular region of the layer are etched and forms a path for the penetration of electrolyte solution through the diamond layer, this path is not a straight path. Due to the small grain size, the path for the penetration of electrolyte solution becomes a labyrinthine path and this path gain time until the electrolyte solution reaches to the carbide interlayer. Then, such diamond electrode structure can clearly extend the life time and improve the stability of diamond electrode. Note that this diamond electrode is not a multilayer structure. This electrode is composed of single layer and basically homogeneous small grains of conductive diamond. Single structure layer have the advantage that can be more easily produced in CVD coating than multilayer coatings. Multilayer structure requires change in the CVD parameter during the coating increasing the complexity of process. Also the meaning of homogeneous small grains used in this application do not means that the sizes of all grains are exactly the same. It means that the small grains with size between 0.1-800 nm in width; preferable in the range between 1-500 nm; more preferable in the range between 1-300 nm are dispersed homogenously in the layer.

However, substrate coating with small diamond grains is a necessary condition but not enough condition to obtain a high stability electrode. As disclosed in the previous art, diamond layer with small grain structure can be easily produced by increasing the concentration of methane in the CVD chamber during the coating process. For example, if methane concentration higher than 2% is used, there is a deposition of small grain over the substrate material. Also if low substrate temperature is used in the coating, for example at 650° C., the obtained layer will be composed of small grain sizes, specifically speaking with grain size smaller than one micrometer.

The present inventor have coated substrate at such CVD condition and tested the produced diamond electrode in an electrolytic reaction. Detail will be described after in the comparative examples, but diamond electrode having small grain size layer produced by high methane concentration or low CVD temperature, clearly fail in short time during the electrolytic reaction. The reason is that the produced diamond layer has a very poor diamond quality. Huge amount of non-diamond sp² carbon are incorporated in the layer resulting in a poor stability of diamond electrode. Beside the small grain size, diamond quality is another necessary requirement to obtain long term stable diamond electrode. The quality of the diamond can be quantitatively analyzed by the ratio between amount of sp³ and sp² carbons in the layer. Diamond quality measured by Raman spectrophotometer, from hereafter will be referred as Raman quality. In the Raman spectra, the sp³ diamond carbons appear as a sharp peak at 1333 cm⁻¹ and non-diamond sp² carbons as a broad peak around 1500 cm⁻¹. Raman quality can be calculated by the area ratio of these two peaks, and 100% Raman quality is the case where the layer is composed of high purity diamond and only the sp³ peak is detected. Usually, the conductive diamond layer produced by CVD process has Raman quality lower than 100%. CVD coating with high methane concentration or low substrate temperature may easily result in diamond layer with low Raman quality, and that are not a good embodiment to produce long term stable diamond electrode.

In the present application, the value of Raman quality (q) is calculated by the following equation (1) and its unit is given in percentage. I_{d} is the area of the diamond phase and I_{nd} is the area of the non diamond phases in the Raman graph.

$$q = \frac{75 \cdot \int {I}_{d}}{75 \cdot \int {I}_{d} + {\sum }_{nd} \int {I}_{nd}} \cdot 100 \% \qquad ( 1 )$$

This quantification of diamond quality can be done by the analysis of diamond layer with a Raman spectrophotometer Type Ramanscope 2000 from Renishaw. This spectrophotometer has a Argon laser with a wavelength of 514.5 nm and a lateral resolution of 1 μm. The measured area at a magnification of 200× was ca. 25 μm. The values of Raman quality used in this application refer to the calculated by above equation and technique, but other techniques or devices can be used for the quantification of diamond quality. In the case that other techniques are used, even for the same diamond coating, some times different values can be found.

According to the embodiment of this invention, Raman quality higher than 50% is another required condition to provide a stable diamond electrode. Raman quality lower than 50% means that sp² carbon is present in a detrimental amount in the diamond layer. Please, note that if other techniques rather than described by equation (1) is used, different values can be obtained. The important feature of this invention is that the proportion of sp³ and sp² carbon stays in a certain range and when measured by the equation (1), it gives a value higher than 50%.

According to the embodiment of this invention, the Raman quality is kept at value higher than 50% and at the same time providing a diamond layer with small grains. Such a feature is achieved by coating the substrate material in the CVD process in a controlled pressure. During the CVD coating, the pressure is kept at value lower than 20 mBar (2 kPa) but higher than 0.01 mBar (1 Pa), preferable at pressure between 15 mBar (1.5 kPa) and 0.1 mBar (10 Pa) and further preferable between 6 mBar (600 Pa) and 1 mBar (100 Pa). The best range for producing a layer with small grain and high Raman quality is when the pressure is between 1 mBar and 6 mBars. If the CVD chamber pressure becomes higher than 20 mBar, the grain size of diamond will become larger facilitating the occurrence of pinholes and other defects in the layer. This low CVD coating pressure adopted in the present invention promotes the secondary nucleation of diamond grains rather than increasing the grain size. This secondary nucleation is promoted during the coating as low as is the CVD pressure. There is a continuous formation of small grain nuclei at low CVD pressure. But on the other hand if the pressure is too low, the absolute density of methane (carbon source) inside CVD chamber becomes also low and the growing rate of diamond layer will also become low. Furthermore, in Hot Filament CVD, if the pressure is too low, there is a problem that sparks can appear at the filament. The sparks can be prevented with an adjusted process setup but if it happens, it will lead to the stop of the coating process. From this reason, the pressure should be higher 0.01 mBar (1 Pa), preferable higher than 0.1 mBar (10 Pa) and further preferable higher than 1 mBar (100 Pa). Therefore, according to the embodiment of this invention, stable diamond electrode composed of small grain size with Raman quality higher than 50% is provided and also the method for producing such diamond electrode with a controlled pressure lower than 20 mBar and higher than 0.01 mBar is provided. The above pressures ranges are valid for Hot Filament CVD and Microwave CVD, when producing diamond layer with small grains size.

Note that, the use of this low CVD pressure is a separate parameter from the methane and hydrogen ratio. The balance of methane concentration and Hydrogen concentration inside the CVD chamber is one important parameter to control the Raman quality. Non-diamond sp² carbon will increase in the diamond layer, as high as is the methane concentration in relation to the hydrogen concentration, because the relative value of hydrogen radical that removes the sp² carbon from the layer will become low. The amount of hydrogen radical in the CVD chamber has to be in a higher or at least stoichiometric amount to react with the sp² carbons formed. For this reason, the concentration of methane in the CVD chamber should be kept at value lower than 2% in relation to the hydrogen gas, but not lower than 0.1%. If the methane concentration becomes lower than 0.1%, also the growing rate of the diamond layer will decrease due to the low absolute amount of the carbon source for sp³ carbon formation.

Therefore, in this invention the grain size of diamond crystals is controlled by the CVD pressure and the diamond quality is controlled by other CVD parameter such as the methane concentration. That means this invention provides a method for producing diamond layer with small grains but without committing the diamond quality.

Accordingly, this invention provides a method for producing diamond electrode by coating a substrate material by CVD process; said diamond electrode having a single and homogeneous layer composed of a poly-crystalline and conductive diamond with grain size lower than one micrometer; said layer having a Raman quality higher than 50%; wherein the said layer is produced by controlling the CVD at pressure lower than 20 mBar; and at methane concentration lower than 2%.

Such features are essential to produce a diamond electrode with improved stability.

Another embodiment of present invention is related to the method for producing the diamond electrode, in which the CVD coating is preceded by a pretreatment step. Such pretreatment step comprises the seeding of substrate with diamond nano crystal. The seed diamonds are important to increase the growing rate of diamond layer during the CVD coating. If there are not any diamond crystals that can work as the nuclei to start the deposition of diamond carbons over the substrate, long coating time will be required. The seed diamond can be impregnated in the substrate by immersing the substrate in a solution containing seed diamond, water and some solvent such as methanol, ethanol or acetone. This impregnation of seed diamond is preferable done in a bath where there is an ultra-sonic treatment. The seed diamonds can not be higher than one micrometer, by obvious reason, if this invention intents to provide a homogeneous layer composed of diamond grains lower than one micrometer. However, the seed diamonds are preferable lower than 200 nm, more preferable lower than 50 nm, further preferable lower than 5 nm. These nano seed crystals are necessary for providing many connection points between the substrate and the diamond layer in order to improve the cohesion of the coating. Furthermore the nano seed crystals reduce the process time until a dense diamond layer is grown by the coalescence of the seed crystals.

In another embodiment of the present invention, a method for producing the diamond electrode, wherein the diamond layer has a thickness of at least one micrometer is provided. The grain size that composes the layer should be small, with size between 0.1-800 nm in width; preferable in the range between 1-500 nm; more preferable in the range between 1-300 nm. However, if the layer thickness is too thin, the probability of electrolyte solution infiltrate in the layer will increase. By this reason, for a long term stable diamond electrode, the layer thickness should be at least of one micrometer, more preferable higher than 5 micrometer; further preferable if higher than 10 micrometer.

This invention also provides a method for producing the diamond electrode, wherein the diamond layer has a boron doping level lower than 1,500 ppm (part per million). The doping level here, refers to the molar ratio between boron and carbon (B/C ratio) in the layer. As high as is the B/C ratio, the electrical conductivity of diamond layer will increase. From the point of view of diamond electrode application, this conductivity has some benefits because it can decrease the voltage between the electrodes during the electrochemical reaction. On the other hand, the boron induces the deposition of sp² (non-diamond)carbons in the layer during the CVD coating. When the B/C ratio is higher than 1,500 ppm the amount of sp² carbons will be in a detrimental amount inside of the layer. The Raman quality of the layer will decrease with the increase in the B/C ratio. For this reason the doping level should be low than 1,500 ppm.

Additionally, this invention provides a method for producing the diamond electrode, wherein the coating is performed in a hot-filament CVD with the filament disposed vertically inside of the CVD chamber. If the filaments are disposed horizontally, there will be a slackening of the filament during the CVD coating due to the thermal expansion of filament wires and due to the gravity. The distance between the filaments and/or between the filament and substrate can not be kept uniform. The slackening of filament tends to occurs because the filament achieves a temperature of 1,800 to 2,400° C. during the HF-CVD coating. The distance between the filaments and/or between the filament and substrate shall be kept in a prescribed value to achieve a homogeneous coating in the whole substrate surface. The slackening of filament do not occur when disposed vertically because the gravity works to stretching the filament wires.

### BRIEF DESCRIPTION OF DRAWINGS

FIG. 1 is a schematic illustration of delamination mechanism originated by pinhole when the diamond layer are composed of grains larger one micrometer; FIG. 1a shows a short path for the penetration of electrolyte solution and FIG. 1b shows the subsequent delamination caused by this penetration of electrolyte solution.

FIG. 2 is a schematic illustration of diamond electrodes composed of under-micrometer particles where the attack of electrolyte solution to the interlayer is suppressed by its long penetration path.

FIG. 3 is a schematic illustration of hot filament CVD process for coating the diamond electrodes, wherein the filament 2 is disposed vertically.

FIG. 4 is a Scanning Electronic Microscope (SEM) picture of the diamond electrode surface produced at CVD pressure of 20 mBar according to the Comparative Ex. 1

FIG. 5 is a Scanning Electronic Microscope (SEM) picture of the diamond electrode surface produced at CVD pressure of 6 mBar according to the Example 1.

FIG. 6 is a schematic illustration of the electrolytic cell used for the stability evaluation of produced diamond electrode.

FIG. 7 is the profile of electrode voltage and current density in function of the electrical charge density per micrometer of electrode thickness during the electrolytic test of diamond electrode produced at 20 mBars and according to the Comparative Ex. 1.

FIG. 8 is the profile of electrode voltage and current density in function of the electrical charge density per micrometer of electrode thickness during the electrolytic test of diamond electrode produced at 6 mBars and according to the Example 1.

FIG. 9 is the profile of electrode voltage and current density in function of the electrical charge density per micrometer of electrode thickness during the electrolytic test of diamond electrode produced at 15 mBars and according to the Example 2.

FIG. 10 is a Scanning Electronic Microscope (SEM) picture of the diamond electrode surface produced at CVD pressure of 6 mBar and methane concentration of 2% according to the Comparative Ex. 2.

FIG. 11 is the profile of electrode voltage and current density in function of the electrical charge density per micrometer of electrode thickness during the electrolytic test of diamond electrode produced at 6 mBars and methane concentration of 2% according to the COMPARATIVE Ex. 2.

FIG. 12 is a Scanning Electronic Microscope (SEM) picture showing the growing behavior of diamond crystal over the substrate material (1.5 hour CVD coating) when the pretreatment was done by seed diamond with average size of 250 nm and according to the Comparative Ex. 3.

FIG. 13 is a Scanning Electronic Microscope (SEM) picture showing the growing behavior of diamond crystal over the substrate material (1.5 hour CVD coating) when the pretreatment was done by seed diamond with average size of 5 nm and according to the Example 3.

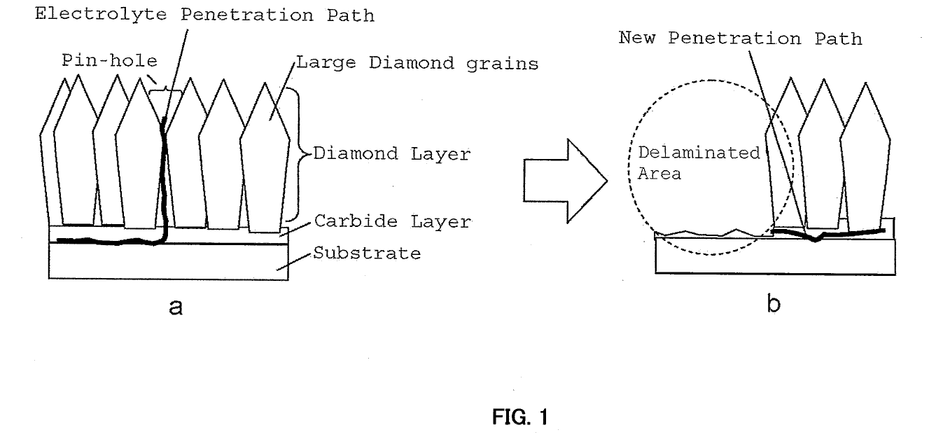

### BEST MODE FOR CARRYING OUT THE INVENTION

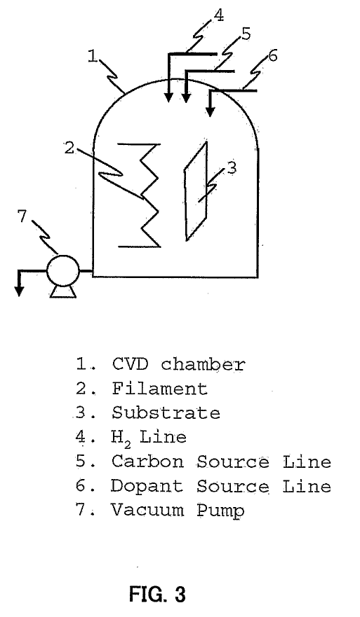

Hereinafter, the embodiment of the present invention will be described in detail and with reference to the COMPARATIVE EX. and EXAMPLES. FIG. 3 illustrates the basic configuration of a HF CVD apparatus that was used for the diamond coating in the COMPARATIVE Ex. and EXAMPLES described hereinafter. However, for the execution of features of present invention, the CVD apparatus are not limited to this one illustrated in this FIG. 3 and can be as well as performed in Micro-wave Plasma CVD. The HF CVD apparatus is comprised by a CVD chamber 1 and a filament 2 disposed inside and vertically. The CVD chamber is a sealed chamber in which the pressure can be kept lower than atmospheric pressure. The control of pressure is achieved by means of vacuum pump 7. Also line 4, line 5 and line 6 are provided to supply the hydrogen, carbon source and a dopant source, respectively. The line 4, line 5 and Line 6 are connected to a mass flow controller (not shown) to keep the respective gases at certain concentration inside the CVD chamber. For an accurate control of the pressure inside of the chamber, a valve for the control of suction rate can be disposed in the line between the chamber and the vacuum pump. The flow rates, including the flow rate of outlet gases and inlet gases in the CVD chamber, can be electronically controlled by automatic systems using computer processors. The substrate 3, which will be coated, is disposed in front of the filament 2. During the coating, the filament is heated at temperature between 1,800-2,400° C. by supplying a direct current to the filament 2. The substrate temperature can be kept at temperature between 700-900° C. by the irradiation of the filament 2. Additional devices for the adjustment of substrate temperature can be used. For example heater can be disposed behind the substrate for this purpose. COMPARATIVE EX. 1 and EXAMPLE 1 show that the CVD pressure can control the grain size of diamond. Comparative example 1 was coated at 20 mBar and Example 1 was coated at CVD pressure of 6 mBar.

### EXAMPLES

### Comparative Ex. 1

The surface of titanium plate (40×60×4t) was pretreated by sand-blasting using SiC powders as the blasting material. The sand-blasted titanium plate, after washing with distilled water, was immersed in an ultra-sonic bath containing aqueous ethanol solution and seed diamond with diameter around 5 nm. The substrate material was treated in this ultrasonic-bath for 10 h. After drying, the substrate material was placed inside the HF-CVD chamber and coated at 20 mBar and at the condition illustrated in TABLE 1 for 20 h.

TABLE 1

| | | COMP. | COMP. | COMP. | | | |
|---|---|---|---|---|---|---|---|
| | | EX. 1 | EX. 2 | EX. 3 | EX. 1 | EX. 2 | EX. 3 |
| Pre- | Seed diamond | 5 | 5 | 250 | 5 | 5 | 5 |
| treatment | Size (nm) | | | | | | |
| CVD | CVD Pressure | 20 | 6 | 6 | 6 | 15 | 6 |
| Condition | (mBar) | | | | | | |
| | Substrate | 750 | 748 | 748 | 748 | 753 | 748 |
| | Temperature (° C.) | | | | | | |
| | Coating Time (h) | 20 | 20 | 1.5 | 20 | 20 | 1.5 |
| | Methane | 1.3 | 2.0 | 1.3 | 1.3 | 1.3 (10 h) | 1.3 |
| | Conc. (Vol %) | | | | | 0.8 (10 h) | |
| | Trimethyl Boran | 0.02 | 0.02 | 0.02 | 0.02 | 0.02 | 0.02 |
| | Conc. (vol %) | | | | | | |
| | Filament | 5,700 | 5,700 | 5,700 | 5,700 | 5,700 | 5,700 |
| | Power (W) | | | | | | |
| Electrode | Layer | 1.7 | 1.7 | n.m. | 1.35 | 1.7 | n.m. |
| Property | thickness (μm) | | | | | | |
| | Raman | 76.7% | 38.5% | n.m. | 52% | 78.5% | n.m. |
| | Quality (%) | | | | | | |
| | Size (mm) | 60 × | 60 × | 60 × | 60 × | 60 × | 60 × |
| | | 40 × 4 t | 40 × 4 t | 40 × 4 t | 40 × 4 t | 40 × 4 t | 40 × 4 t |

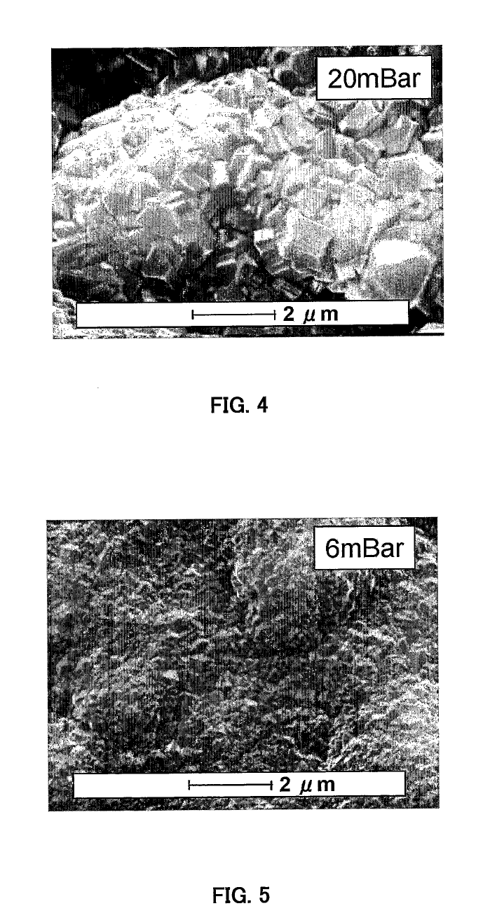

The produced electrode had a diamond layer of 1.7 μm. FIG. 4 illustrates a SEM picture of the produced diamond layer. A lot of grains are larger than one micrometer. In average, the grains produced by coating at 20 mBar are larger.

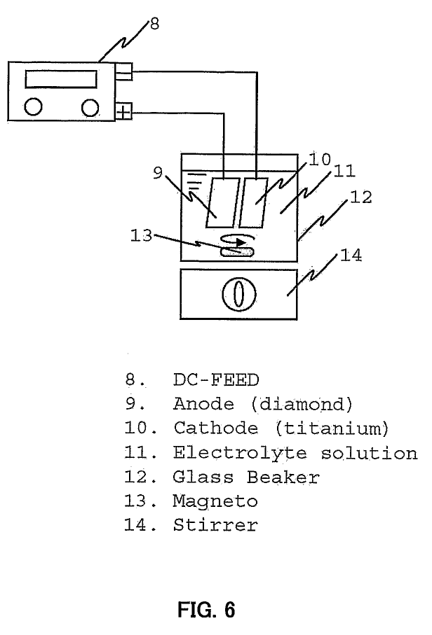

The stability of diamond electrode was tested in an electrochemical cell as illustrated in FIG. 6. The direct current was supplied to the electrode by a DC-FEED 8. The DC-FEED is connected to Anode 9 and the Cathode 10. The diamond electrode of COMPARATIVE EX. 1 was used as the anode and a titanium plate was used as the cathode.

The testing electrolyte solution 11 was composed of aqueous solution containing 20 g per litter of acetic acid and 0.1M of sodium sulfate as supporting electrolyte. The electrolyte solution was filled in a glass beaker 12. During all the test period, the solution was stirred by means of a magnetic mixer 13 and a stirrer 14. The gap between the electrodes was kept at 4 mm.

The electrochemical cell was operated at a galvanostatic condition, that means, the DC-Feed 8 was operated at constant current and the electrode was controlled at constant current density of 150 mA/cm².

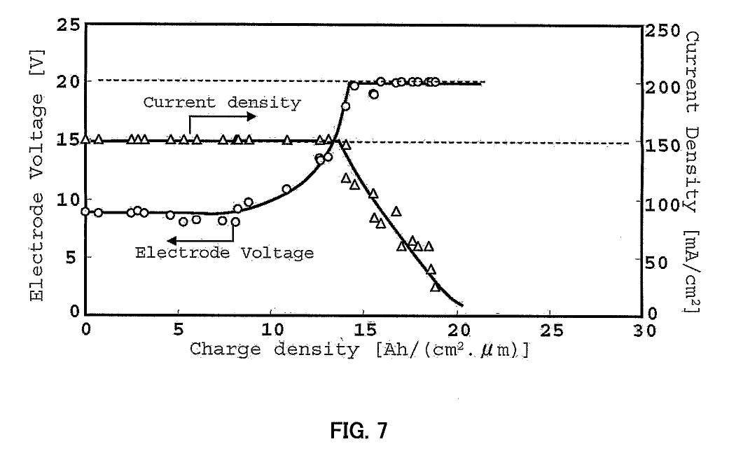

FIG. 7 illustrates the profile of voltage between the electrodes (left vertical axis) and the current density (right vertical axis) in function of the electrical charge density per micrometer of diamond layer thickness (horizontal axis). The electrical charge density per micrometer of diamond layer thickness, hereinafter referred as charge density, which the unit is given in Ah/(cm²·μm), indicates the amount of electrical charge (Ah) that was passed in a square centimeter of electrode area divided by the thickness of diamond layer. As high is this value, higher will be operation time of electrode taking into the account the current density and thickness of diamond layer. Accordingly, this charge density is a good reference to evaluate the stability of the electrode.

The electrode produced in COMPARATIVE Ex. 1, as can be seen in FIG. 7, after passing a charge density of roughly 10 Ah/(cm²·μm) shows an increase in the voltage between the electrodes. This increase in the voltage is due to decrease of effective area of diamond electrode by the delamination of diamond layers. Between the diamond layer and the titanium substrate, there is a thin interlayer of titanium carbide. But because this titanium carbide layer is not chemically stable against the attack of electrolyte solution, the titanium carbide layer quickly dissolves exposing the titanium substrate. After the delamination, the exposed titanium substrates are passivated by the formation of titanium oxide layer which is a ceramic form of titanium and electrically not conductive. Then, the delaminated area becomes electrically not conductive, causing the increase in the voltage between the electrodes. This point where the electrode voltage starts to increase is used as a reference for the charge density where the electrode starts to fail by delamination. When further continuing the electrochemical reaction, there is a point where the reaction can not be kept more at galvanostatic condition because the voltage between the electrodes achieves the maximum capacity that the DC-supply can supply. In the case of COMPARATIVE and EXAMPLES described in this application, the used DC-Feed had a maximum capacity of 20V. In COMPARATIVE EX. 1, the current density started to decrease after passing a charge density of 14 Ah/(cm²·μm). After passing a charge density of around 20 Ah/(cm²·μm), this electrode was found to be completely failed with the whole surface delaminated, and current density decreasing to values near zero.

### Example 1

The surface of titanium plate (40×60×4t) was pretreated by sand-blasting using SiC powder as the blasting material. The sand-blasted titanium plate after washing with distilled water, was immersed in an ultra-sonic bath containing aqueous ethanol solution and seed diamond with diameter around 5 nm. The substrate material was treated in this ultrasonic-bath for 10 h. After drying, the substrate material was placed inside the HF-CVD chamber and coated at 6 mBar and at the condition illustrated in TABLE 1 for 20 h.

The produced electrode had a diamond layer of 1.35 μm. FIG. 5 illustrates a SEM picture of the diamond electrode surface produced in EXAMPLE 1. As can be seen, the grains of diamond crystal are very small and this is due to fact that this electrode was coated at CVD pressure of 6 mBar. The grain sizes are lower than one micrometer, which can be confirmed by the reference bar of 2 μm illustrated in FIG. 5. Comparing with FIG. 4 where the coating was performed at CVD pressure of 20 mBar, the grains produced by coating at CVD pressure of 6 mBar, as illustrated in FIG. 5, are clearly small, proofing that CVD pressure is one important parameter that can control the crystal size of diamond layer. An AFM (atomic force microscopy) analysis showed that the grain size in the EXAMPLE 1 had a grain size of around 300 nm.

The stability of diamond electrode was tested in an electrochemical cell as illustrated in FIG. 6. The direct current was supplied to the electrode by a DC-FEED 8. The DC-FEED was connected to Anode 9 and the Cathode 10. The diamond electrode of EXAMPLE 1 was used as the anode and a titanium plate was used as the cathode.

The testing electrolyte solution 11 was composed of aqueous solution containing 20 g per litter of acetic acid and 0.1M of sodium sulfate as supporting electrolyte. The electrolyte solution was filled in a glass beaker 12. During all the test period, the solution was stirred by means of a magnetic mixer 13 and a stirrer 14. The gap between the electrodes was kept at 4 mm.

The electrochemical cell was operated at a galvanostatic condition, that means, the DC-Feed 8 was operated at constant current and the electrode was controlled at constant current density of 150 mA/cm².

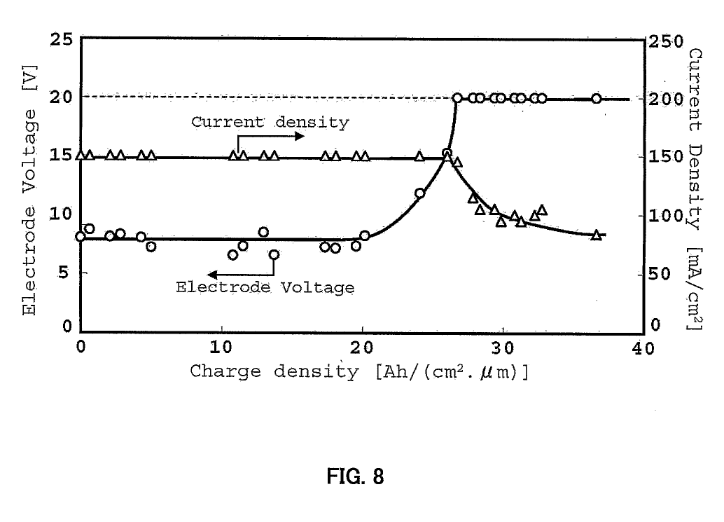

FIG. 8 illustrates the profile of voltage between the electrodes (left vertical axis) and the current density (right vertical axis) in function of the electrical charge density per micrometer of diamond layer thickness (horizontal axis) for the electrode produced in EXAMPLE 1.

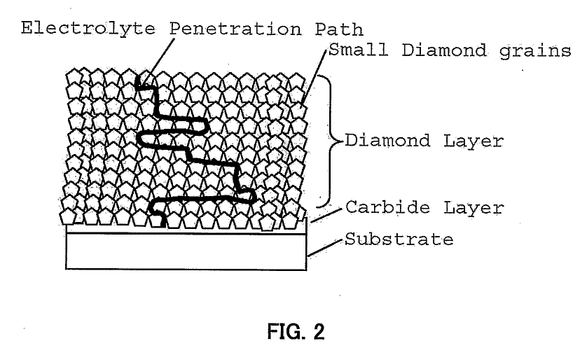

The voltage between the electrode in EXAMPLE 1 started to increase only when passing a charge density higher than 20 Ah/(cm²·μm). The value of charge density where the electrode voltage started to increase in COMPARATIVE EX. 1 (FIG. 7) was 10 Ah/(cm²·μm). That means the electrode of EXAMPLE 1 started to delaminate only when passing the double of charge density compared to the electrode of COMPARATIVE EX. 1. Also referring to the value of Raman quality illustrated in Table 1, it is clear that the electrode of COMPARATIVE Ex. 1 has higher Raman quality (76.7%) rather than the electrode of EXAMPLE 1 (52%). The amount of sp³ carbon and the diamond quality in the layer are higher in COMPARATIVE EX. 1, rather than in EXAMPLE 1. Even with this advantage in the Raman quality, the electrode of COMPARATIVE EX. 1 started to fail by delamination prior to the electrode of EXAMPLE 1. That is due to the fact that the grain size of diamond layer in EXAMPLE 1 has small grain structure which avoids or makes difficult the penetration of electrolyte solution by the mechanism illustrated in FIG. 2.

The electrode of EXAMPLE 1 achieved a voltage of 20V after passing a charge density of 26 Ah/(cm²·μm) and the following continuation of electrolytic solution had a decrease in current density. Note that in COMPARATIVE EX. 1 the current density started to decrease at 14 Ah/(cm²·μm), showing that the stability of electrode in EXAMPLE 1 is clearly better than the electrode of COMPARATIVE EX. 1.

### Example 2

The surface of titanium plate (40×60×4t) was pretreated by sand-blasting using SiC powder as the blasting material. The sand blasted titanium plate, after washing with distilled water, was immersed in an ultra-sonic bath containing aqueous ethanol solution and seed diamond with diameter around 5 nm. The substrate material was treated in this ultrasonic-bath for 10 h. After drying, the substrate material was placed inside the HF-CVD chamber and coated at 15 mBar and at the condition illustrated in TABLE 1 for 20 h in total. Here, the electrode was coated by 10 h using methane concentration of 1.3% and at the following 10 h the methane was changed to 0.8%.

The produced electrode had a diamond layer of 1.7 μm. The Raman quality of the produced layer was 78.5% showing that the decrease in methane concentration during the CVD coating can increase the Raman quality. The grain sizes were lower than one micrometer, with an average size of 700 nm confirmed by SEM and AFM analysis. The grains sizes were lower than that one produced at CVD pressure of 20 mBar and illustrated in FIG. 4 (COMPARATIVE EX. 1).

The stability of diamond electrode was tested in an electrochemical cell as illustrated in FIG. 6. The direct current was supplied to the electrode by a DC-FEED 8. The DC-FEED was connected to Anode 9 and the Cathode 10. The diamond electrode of EXAMPLE 2 was used as the anode and a titanium plate was used as the cathode.

The testing electrolyte solution 11 was composed of aqueous solution containing 20 g per litter of acetic acid and 0.1M of sodium sulfate as supporting electrolyte. The electrolyte solution was filled in a glass beaker 12. During all the test period, the solution was stirred by means of a magnetic mixer 13 and a stirrer 14. The gap between the electrodes was kept at 4 mm.

The electrochemical cell was operated at a galvanostatic condition, that means, the DC-Feed 8 was operated at constant current and the electrode was controlled at constant current density of 150 mA/cm².

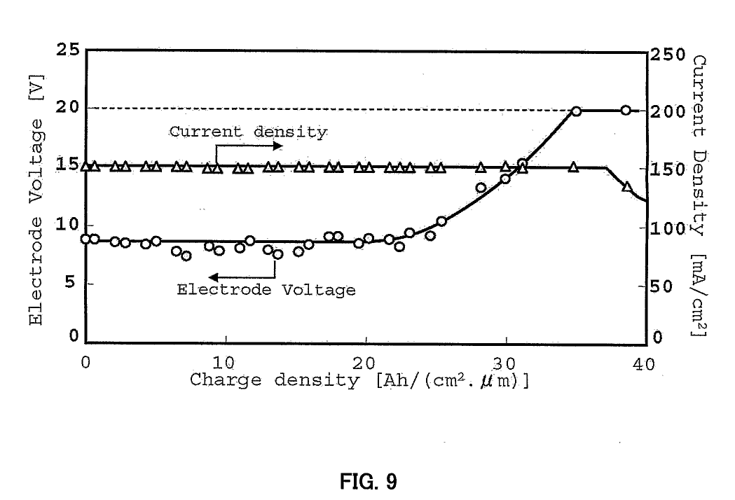

FIG. 9 illustrates the profile of voltage between the electrodes (left vertical axis) and the current density (right vertical axis) in function of the electrical charge density per micrometer of diamond layer thickness (horizontal axis) for the electrode produced in EXAMPLE 2.

The voltage between the electrode in EXAMPLE 2 started to increase only when passing a charge density higher than 24 Ah/(cm²·μm). The value of charge density where the electrode voltage started to increase in COMPARATIVE EX. 1 (FIG. 7) was 10 Ah/(cm²·μm). In comparison, the electrode of EXAMPLE 2 started to delaminate only when passing more than the double of charge density. The value of Raman quality and diamond layer thickness has almost the same values when comparing EXAMPLE 2 and COMPARATIVE EX. 1, as illustrated in Table 1. However, stability of electrode in EXAMPLE 2 was more than the double of that one in COMPARATIVE EX. 1. This is due to the fact that the grain size of diamond layer in EXAMPLE 2 has small grain structure which avoids or makes difficult the penetration of electrolyte solution by the mechanism illustrated in FIG. 2.

The electrode of EXAMPLE 2 achieved a voltage of 20V after passing a charge density of 35 Ah/(cm²·μm) and the following continuation of electrolytic solution caused a decrease in current density. Note that in COMPARATIVE EX. 1 the current density started to decrease at 14 Ah/(cm²·μm), showing that the stability of electrode in EXAMPLE 2 is clearly better than the electrode of COMPARATIVE EX. 1. Also comparing the EXAMPLE 1 and EXAMPLE 2 (see FIG. 8 and FIG. 9), the stability was better in EXAMPLE 2, due to the higher thickness and higher Raman quality (see Table 1).

### Comparative Ex. 2

The surface of titanium plate (40×60×4t) was pretreated by sand-blasting using SiC powders as the blasting material. The pre-treated titanium plate, after washing with distilled water, was immersed in an ultra-sonic bath containing aqueous ethanol solution and seed diamond with diameter around 5 nm. The substrate material was treated in this ultrasonic-bath for 10 h. After drying, the substrate material was placed inside the HF-CVD chamber and coated at 6 mBar with methane concentration of 2% and at the condition illustrated in TABLE 1 for 20 h.

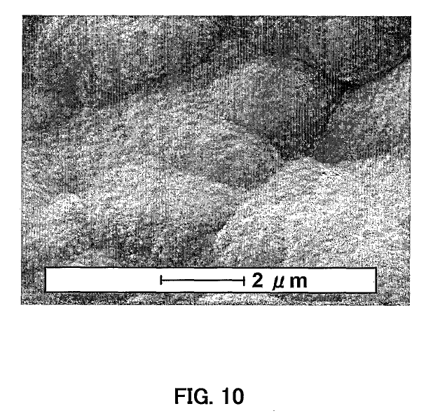

The produced electrode had a diamond layer of 1.7 μm. FIG. 10 illustrates a SEM picture of the produced diamond layer. The grains sizes are very small ranging around 100 nm, confirmed by AFM analysis. This small grain size is a result of the CVD coating at low pressure and high methane concentration. This demonstrates that the use of low pressure as well as high methane concentration can decrease the size of grains in the diamond layer. The stability of this diamond electrode was tested in an electrochemical cell as illustrated in FIG. 6. The direct current was supplied to the electrode by a DC-FEED 8. The DC-FEED is connected to Anode 9 and the Cathode 10. The diamond electrode of COMPARATIVE EX. 2 was used as the anode and a titanium plate was used as the cathode.

The testing electrolyte solution 11 was composed of aqueous solution containing 20 g per litter of acetic acid and 0.1M of sodium sulfate as supporting electrolyte. The electrolyte solution was filled in a glass beaker 12. During all the test period, the solution was stirred by means of a magnetic mixer 13 and a stirrer 14. The gap between the electrodes was kept at 4 mm.

The electrochemical cell was operated at a galvanostatic condition, that means, the DC-Feed 8 was operated at constant current and the electrode was controlled at constant current density of 150 mA/cm².

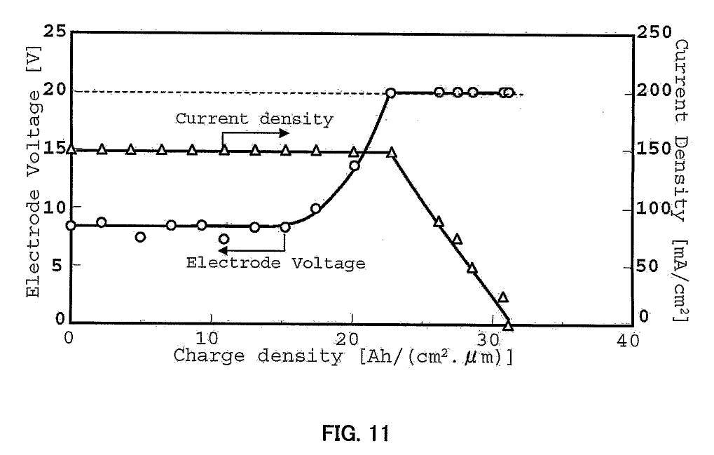

FIG. 11 illustrates the profile of voltage between the electrodes (left vertical axis) and the current density (right vertical axis) in function of the electrical charge density per micrometer of diamond layer thickness (horizontal axis) for the electrode produced in COMPARATIVE Ex. 2.

The voltage between the electrode in COMPARATIVE EX. 2 started to increase after passing a charge density of 15 Ah/(cm²·μm). The value of charge density where the electrode voltage started to increase in COMPARATIVE EX. 2 was clearly low than EXAMPLE 1 and EXAMPLE 2. Despite the diamond layer of COMPARATIVE Ex. 2 is composed of small grain size, the stability are lower than EXAMPLE 1 and EXAMPLE 2. This is due to the low Raman quality of this electrode as can be seen in Table 1. The Raman quality in this COMPARATIVE EX. 2 was 38.5%, and this low diamond quality is because this electrode was coated at a methane concentration of 2%. This shows that, when increasing the methane concentration during the CVD coating, it is possible to produce layer with fine particle. However, because the quality of diamond layer produced at this condition is low, the stability of electrode is also low. To have a stable diamond electrode, the small grain size is not condition enough. Also the Raman quality is another requirement. The Raman quality of the layer has to be higher than 50%, to obtaining a stable diamond electrode. In this case, the factor that is decreasing the Raman quality is the high methane concentration. Methane concentration of 2% allows to obtaining layer composed of small particle but it also causes the decrease of quality of diamond layer. In other words, to improve the stability of diamond electrodes, it is preferable to make the coating using methane concentration lower than 2%.

The electrode of COMPARATIVE Ex. 2, after passing a charge density of 22 Ah/(cm²·μm) achieve 20V during the electrolytic test. In further continuation of the test, the galvanostatic condition could not be kept, with decrease in current density.

In all Comparative Ex. and Examples, while the electrode did not fail, the Acetic Acid in the electrolyte solution was degraded to carbon dioxide and water during the electrolytic test. The degradation of Acetic acid was monitored by COD (Chemical Oxygen Demand) measurement and there was a clear decrease of COD during the electrolytic test. The COD decreased at a rate of near 3.35 Ah/g-COD. This decrease in COD was due to the oxidation of acetic acid by the OH radical produced at the diamond electrode.

### Example 3 and Comparative Ex. 3

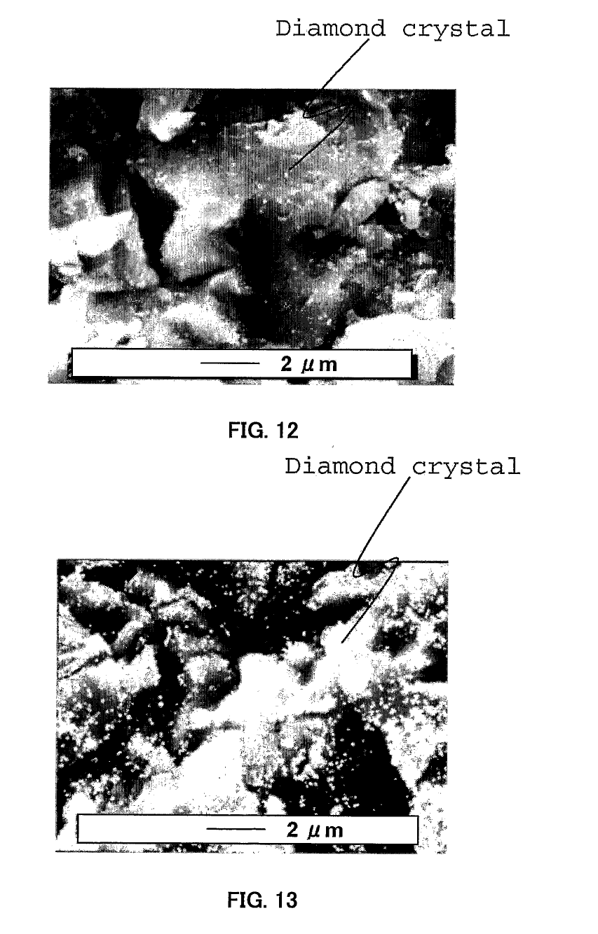

Example 3 and Comparative Ex. 3 illustrate the influence of the size of seed diamonds in the growth behavior of diamond crystal during the CVD coating. Surface of two titanium plate (40×60×4t) were pretreated by sand-blasting using SiC powders as the blasting material. The pre-treated titanium plates, after washing with distilled water, were immersed in an ultra-sonic bath containing aqueous ethanol solution and seed diamond. The seed diamond used for Example 3 and Comparative Ex. 3 have an average diameter of 5 nm and 250 nm respectively. The substrates were treated in this ultrasonic-bath for 10 h. After drying, the substrates were placed inside the HF-CVD chamber and coated at 6 mBar with methane concentration of 1.3%. The coating was interrupted after 1.5 h to see the difference of growing behavior of the diamond crystal over the substrate. The CVD condition for Comparative Ex. 3 and Example 3, as illustrated in Table 1, were exactly the same except in the difference in the size of seed diamond during the pretreatment. The Raman quality and the layer thickness were not measured (nm) in Comparative Ex. 3 and Example 3, because due to the short time coating. The coating time was not enough for the formation of a layer over the substrate. FIG. 12 and FIG. 13 illustrates the SEM picture after the CVD coating for Comparative Ex. 3 and Example 3, respectively. The white small points in this picture are the diamond crystal. As can be seen in FIG. 12, when diamond of 250 nm was used as the seed, the number of diamond crystal that can be recognized by the SEM are scattered and in low quantity. In comparison, as can be seen in FIG. 13, when diamond size of 5 nm is used as the seed, a lot of small crystal can be recognized over whole surface of substrate. Therefore, it is clear that when nano-sized diamonds are used as the seed, the formation of a dense diamond layer over the substrate will be faster than large seed. The process time until a dense diamond layer is grown to the whole substrate surface by the coalescence of the seed crystals can be shortened using seeds of nano diamonds. The size of seed nano diamonds are preferable lower than 200 nm, more preferable lower than 50 nm and further preferable when lower than 5 nm.

### INDUSTRIAL APPLICABILITY

A method for production of diamond electrodes with improved stability is provided in the present invention. In the present invention, a diamond electrode, having at least one poly-crystalline and conductive diamond layer, the layer having grain size lower than one micrometer with Raman quality higher than 50%, is coated by a CVD process controlling the pressure to lower than 20 mBar.

1. A method for producing diamond electrode by coating a substrate material by CVD process;
said diamond electrode having a single and homogeneous layer composed of a poly-crystalline and conductive diamond with grain size lower than one micrometer;
said layer having a Raman quality higher than 50%;
wherein the said layer is produced by controlling the CVD
at pressure lower than 20 mBar; and
at methane concentration lower than 2%.

2. The method for producing the diamond electrode according to the claim 1, further comprises a pretreatment step before CVD process,
said step comprising a procedure where nano-sized diamonds are used as seed crystals.

3. The method for producing the diamond electrode according to the claim 1, wherein the diamond layer has a thickness of at least one micrometer.

4. The method for producing the diamond electrode according to the claim 1, wherein the diamond layer has a boron doping level lower than 1500 ppm.

5. The method for producing the diamond electrode according to the claim 1, wherein the CVD process comprises a hot-filament CVD process, where the filament are disposed vertically.
